(19) United States
(12) Patent Application Publication
(10) Pub. No.: US 2005/0181327 A1
(43) Pub. Date: Aug. 18, 2005

(54) Disposable protective sleeve for temporarily covering hand-held dental light curing guns

(76) Inventors: Jack Graham, Lincoln, MA (US); Jay Steinberg, Marlboro, NJ (US)

Correspondence Address: Brian M. Dingman;Mirick, O'Connell, DeMallie & Lougee, LLP, 1700 West Park Drive, Westborough, MA, 01581-3941, US

(21) Appl. No.: 10/779,228

(22) Filed: Feb. 13, 2004

(51) Int. Cl. A61C 1/16; A61C 3/00

(52) U.S. Cl. 433/116; 433/29

(57) ABSTRACT

A disposable protective sleeve for temporarily covering a hand-held dental light curing gun having an elongated handle portion and a barrel portion that tapers to a transmitting end having a light guide from which light emanates, the gun having a curved transitional portion between the handle portion and the barrel portion. The disposable protective sleeve is made from a flexible plastic elongated tubular body with an opening at one or both ends. The body defines a generally straight proximal section and a curved section. The larger end opening is larger than the transmitting end, the barrel portion, the transitional portion and the handle portion of the curing gun, so that the sleeve is adapted to be placed over at least most of the curing gun by passing the larger end opening over the transmitting end, barrel portion, transitional portion and handle portion of the curing gun, so that the sleeve covers at least the transitional portion and at least most of the handle portion of the gun.

### FIELD OF THE INVENTION

This invention relates to the field of disposable protective covers for dental instruments.

### BACKGROUND OF THE INVENTION

Disposable protective covers have been used for dental instruments. The covers help prevent the spread of infection. Such covers have been used on dental light curing guns, for example, as disclosed in U.S. Pat. Nos. 5,328,368 and 5,302,124. These covers are particularly adapted for a particular model or type of light curing gun. These guns have a generally “T”-shaped body, much like a portable hairdryer. The upper part of the body has vent openings in the front and rear. The protective sleeves are designed to have openings through which the front and rear sections of the gun protrude, to allow venting of the guns while they are covered with the protective sleeve.

Although these sleeves are effective for protecting these types of dental light curing guns, their particular design makes them difficult or impractical with more modern LED-based dental light curing guns. Examples of LED-based light curing guns include the “L.E. Demetron”™ product made by Kerr Corporation, Danbury, Conn., the “Elipar” from 3M ESPE, Radii from SDI Inc., “Unilite”™ from Bien Air, “Rembrandt Allegro LED”™ from Den-Mat, “Flash Lite”™ from Discus Dental, “Hilux LED 3”™ from First Medica, “Sun Light LED”™ from Kinetic Instruments, “Translux”™ from Heraeus Kulzer, and “E-Light”™ from G.Z. America. These products, and other LED-based dental light curing guns, are shaped like curved continuous wands rather than the “T” shape of non LED-based guns. The existing protective sleeves are thus awkward to use on these LED-based light curing guns.

### SUMMARY OF THE INVENTION

It is therefore an object of this invention to provide a disposable protective sleeve for hand-held dental light curing guns that are generally shaped like curved continuous wands.

It is a further object of this invention to provide such a sleeve that protects from the user actually touching the gun while in use, while at the same time providing for proper ventilation of the gun.

This invention features a disposable protective sleeve for temporarily covering a hand-held dental light curing gun having an elongated handle portion and a barrel portion that tapers to a transmitting end having a light guide from which light emanates, the gun having a curved transitional portion between the handle portion and the barrel portion. The disposable protective sleeve is made from a flexible plastic elongated tubular body open at one or both ends. The larger end opening is larger than the transmitting end, the barrel portion, the transitional portion and the handle portion of the curing gun, so that the sleeve is adapted to be placed over at least most of the curing gun by passing the larger end opening over the transmitting end, barrel portion, transitional portion and handle portion of the curing gun, so that the sleeve covers at least the transitional portion and at least most of the handle portion.

The tubular body may define a curved section, and relatively straight sections on both sides of the curved section. The straight sections may extend from the curved section to or close to the ends of the body. The tubular body may define a narrowed section at its distal end, for covering the gun's light guide. The straight section extending from the curved section toward the narrowed end may be tapered toward the distal end. The sleeve end having the larger opening may be larger than the larger opening.

The disposable protective sleeve may further comprise at least one intermediate opening in the sleeve to allow communication between the curing gun and the atmosphere. The curing gun may have one or more venting areas, each venting areas defining one or more venting openings to allow for cooling of the gun, in which case the sleeve may define one or more intermediate openings located to expose the curing gun venting areas, to facilitate heat transfer from the curing gun. The sleeve body may be made from plastic panels joined along at least portions of their edges.

Featured in a more specific embodiment is a disposable protective sleeve for temporarily covering a hand-held dental light curing gun having an elongated handle portion and a barrel portion that tapers to a transmitting end having a light guide from which light emanates, the gun having a curved transitional portion between the handle portion and the barrel portion, the disposable protective sleeve comprising a flexible plastic elongated tubular body open at one end, wherein the tubular body defines a relatively straight section on both sides of a curved section, wherein the straight sections extend from the curved section toward the ends of the body, wherein the body defines at least one intermediate opening to allow communication between the curing gun and the atmosphere, and wherein the opening is larger than the transmitting end, the barrel portion, the transitional portion and the handle portion of the curing gun, so that the sleeve is adapted to be placed over the entire curing gun by passing the end opening over the transmitting end, barrel portion, transitional portion and handle portion of the curing gun, to thereby place the narrowed end over the transmitting end of the gun, so that the sleeve covers the entire gun. The distal straight section extending from the curved section toward the narrowed end may be tapered toward the distal end of the sleeve.

### BRIEF DESCRIPTION OF THE DRAWINGS

Other objects, features and advantages will occur to those skilled in the art from the following description of the preferred embodiments, and the accompanying drawings, in which:

FIG. 1 is an elevational view of an LED-based dental light curing gun;

FIG. 2 is a similar view of the dental light curing gun shown in FIG. 1 covered with one embodiment of the disposable protective sleeve of this invention;

FIG. 3 is an elevational view of the disposable protective sleeve shown in FIG. 2;

FIG. 4 is a partially disassembled view of the disposable protective sleeve shown in FIG. 3, helpful in understanding the preferred method of manufacturing the sleeve of this invention;

FIG. 5 is a view similar to that of FIG. 3 for an alternative preferred embodiment of the invention;

FIG. 6 is an elevational view similar to that of FIG. 1 but for an LED-based dental light curing gun with the distal fiber optic tip attached;

FIG. 7 is a view similar to that of FIG. 3 but for the preferred embodiment of the invention, designed to cover the entire distal end of an LED-based dental light curing gun;

FIG. 8 is an elevational view of another alternative preferred embodiment of the sleeve of the invention; and

FIG. 9 is an elevational view of yet another embodiment of the sleeve of the invention.

### DETAILED DESCRIPTION OF THE PREFERRED EMBODIMENTS

The invention comprises a disposable protective sleeve for covering a hand-held dental light curing gun of the type that is generally LED-based, and shaped like a curved wand, having a generally straight elongated handle portion that is held by the user, and a curved transitional portion leading from the handle portion to a shorter generally straight end barrel portion that tapers to a transmitting end. The transmitting end is adapted to receive a removable fiber optic light guide that transmits the light from the LED in the curing gun to the tooth surface having the composite material that is being cured by the light emitted from the curing gun. The inventive sleeve comprises a flexible plastic elongated tubular body that is open at one or both ends. When there are two openings, one end opening of the tubular body is smaller than the other end opening, with the smaller end opening larger than the transmitting end of the curing gun but smaller than the width of the transitional portion of the curing gun, so that this end will snuggly lie against the tapered region between the transmitting end and the curved transitional portion of the gun. The large end opening of the tubular body is larger than all of the different portions of the curing gun so that it can be slipped over the gun from the distal transmitting end. When the sleeve is in place, it covers at least the transitional portion, and at least most of the handle portion of the curing gun. Preferably, the sleeve covers the entire gun, including the light-emitting tip. For curing guns that include openings in the body to help dissipate heat from the guns, the tubular body of the inventive sleeve can include one or more openings to expose the openings in the gun to the atmosphere, to assist in heat transfer from the gun.

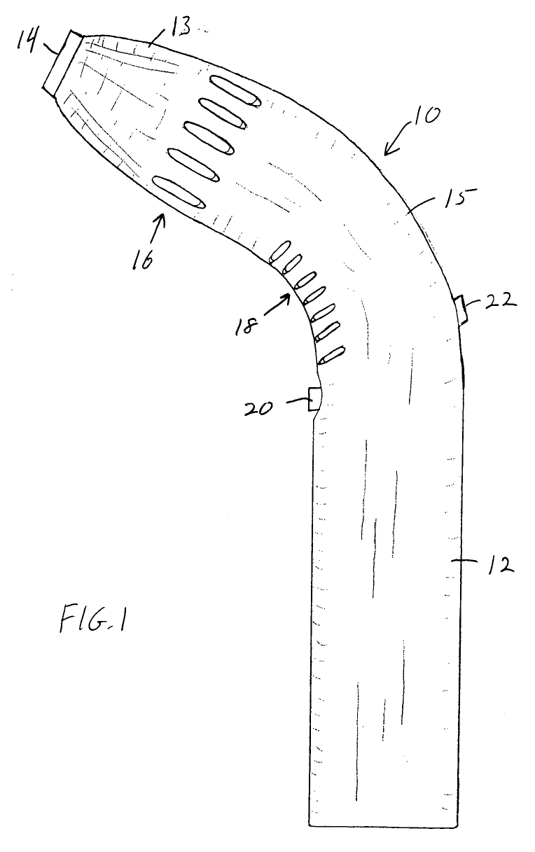

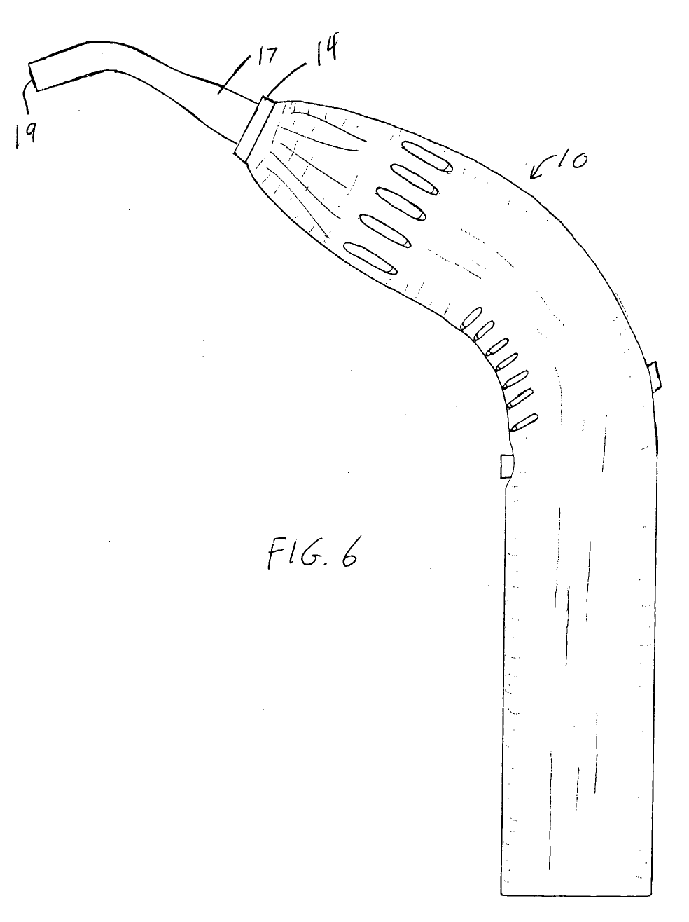

There is shown in FIG. 1 curved, wand-shaped dental light curing gun 10 of the type that is adapted to be covered by the disposable protective sleeve of the invention. Gun 10 comprises generally straight proximal handle portion 12 that is gripped in user's hand when gun 10 is used. Typically, on-off switch 20 is manipulated by the user's index finger to control the emission of light from transmitting end 14. Transmitting end 14 is adapted to have removably coupled to it a fiber optic light guide (not shown in this drawing) that conducts the light from end 14 to the tooth being treated. See FIG. 6 for a fully assembled view of such a gun.

Dental light curing gun 10 further comprises curved transitional portion 15 between handle portion 12 and straight tapered barrel portion 13. The cross-sectional shape of gun 10 is generally approximately oval or circular. Second user-operable switch 22 may be included for other control purposes. Venting areas 16 and 18 define venting openings in the case of the curing gun that provide for convective heat transfer from the gun.

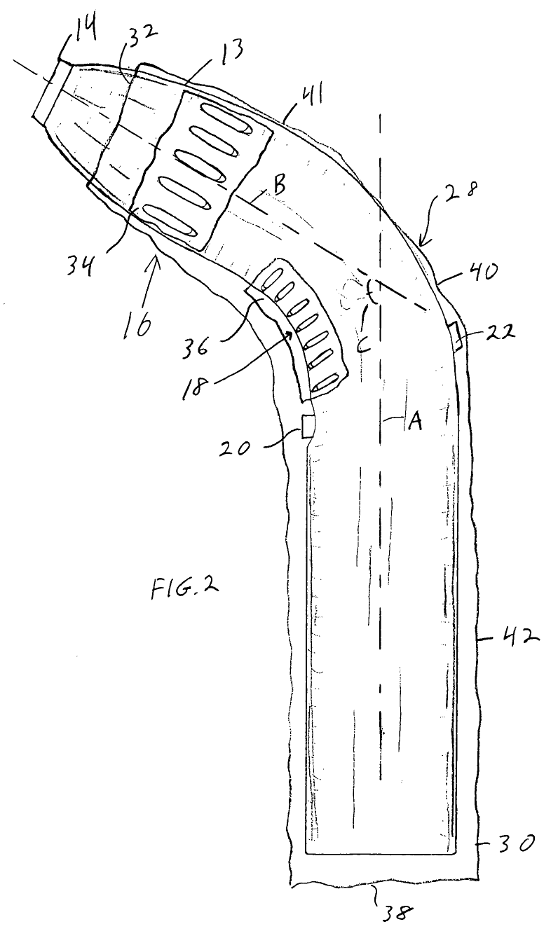

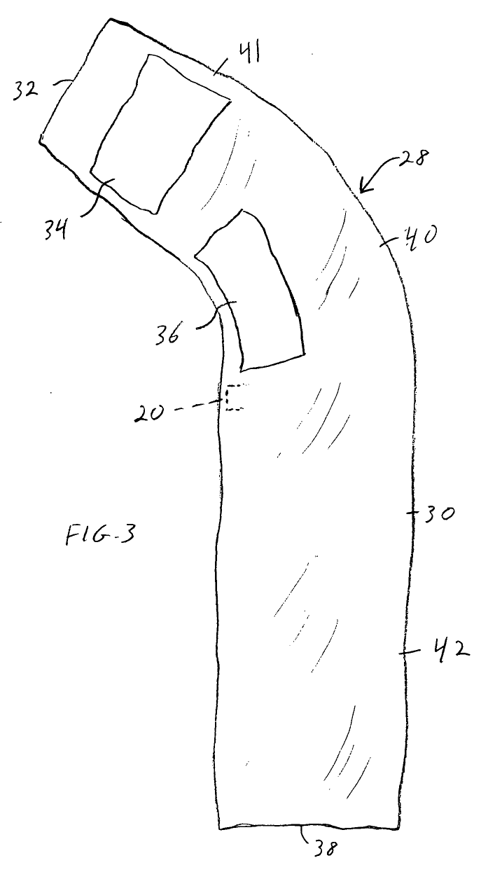

Gun 10 is shown protected by one embodiment of the sleeve 28 of this invention in FIG. 2. Disposable protective sleeve 28 is shown in detail in FIG. 3. Sleeve 28 comprises a flexible plastic elongated tubular body 30 with a smaller opening 32 at the distal end, and a larger opening 38 at the proximal end. Opening 32 is larger than transmitting end 14 but is smaller than the greatest diameter of barrel portion 13 so that opening 32 will relatively snuggly fit onto the gun somewhere between transmitting end 14 and first gun venting area 16 located in barrel portion 13. Larger opening 38 is larger than the largest diameter of gun 10. This allows sleeve 28 to be placed onto gun 10 by slipping opening 38 over transmitting end 14 and then pulling the sleeve down over gun 10 until opening 32 comes to rest along the tapered portion of barrel 13.

The main objective of sleeve 28 is to cover the areas of gun 10 that are held by the user. Primarily, this is handle portion 12 and the area around switch 20. Thus, sleeve 28 could be made shorter than that as shown in FIG. 2, with the top perhaps not even covering venting area 16. However, with curing guns that have a tapered barrel portion, if the smaller opening in the sleeve is about the size of the gun diameter along this tapered region, then the sleeve will naturally cover the gun from the proximal end of handle portion 12 up to this tapered portion of tapered barrel 13.

Sleeve 28 defines intermediate openings 34 and 36 that fall in the area of venting areas 16 and 18, respectively, of gun 10. This allows the venting areas to communicate with the atmosphere, to allow for convective cooling of the gun when it is covered by the sleeve.

Sleeve 28 is preferably arranged such that straight, tapered distal section 41 is coupled to straight proximal section 42 by curved section 40. The straight sections 41 and 42 preferably extend to the ends of the sleeve, or, when one end is closed, preferably extend close to the distal end in order to accommodate a curved light emitting gun tip. Central axes A and B of sections 42 and 41, respectively (FIG. 2), preferably meet at obtuse angle C. Such is not a limitation of the invention, however, as the tubular body could be straight and, since it is flexible, it still could be pulled over the curved shape of the curing light gun. When used on a gun as shown in FIG. 1, however, a straight sleeve would bunch on the inside of the curved section proximate venting area 18 and switch 20. This bunching would potentially interfere with the operation of gun 10, and thus is not preferred.

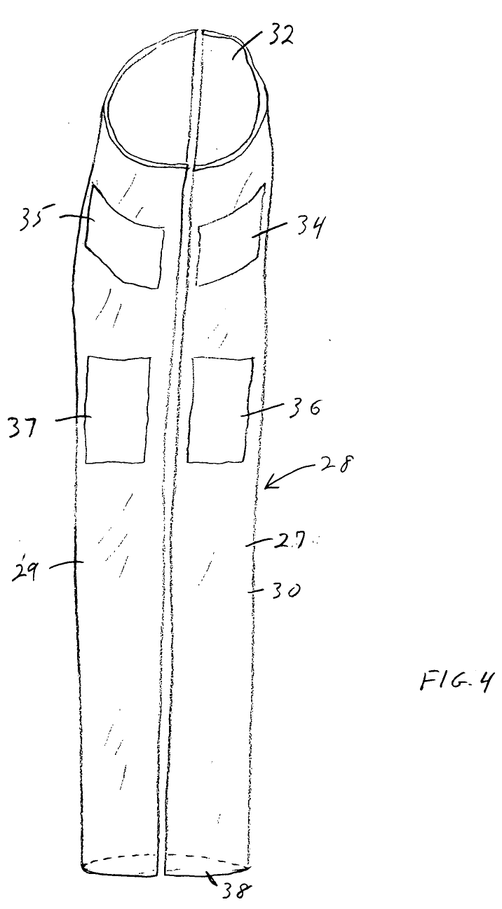

One manner in which sleeve 28 can be assembled is shown in FIG. 4, which is effectively a disassembled view of sleeve 28. The sleeve of the invention is preferably made from two thin flexible plastic sheets. The sheets are preferably clear. The sheets can be die cut and then sealed together along their long edges, while leaving ends 32 and 38 unsealed to provide the two end openings. FIG. 4 depicts both sheets 27 and 29 that together comprise sleeve 28. Sheets 27 and 29 are mirror images of one another, thus having effectively identical openings 36 and 37, and 34 and 35, to expose the generally bilaterally symmetric series of openings of the curing gun.

Alternatively, the sleeve of the invention could be extruded as a tube which was then die cut to create the intermediate openings. In the embodiment in which the distal end of the sleeve is tapered, this taper could be created by die cutting only the distal end of the extruded tube and then heat sealing the die cut edges, or perhaps by heat shrinking or another manner of manipulating the plastic film to create the taper. Alternatively, as described in more detail below, a result of a smaller opening at the distal end can be accomplished by making the entire tube of a diameter equal to the diameter of the largest opening, and then heat sealing a portion of the distal end to decrease the opening to a desired size, that being the diameter of the barrel portion on which the distal end of the sleeve is adapted to rest.

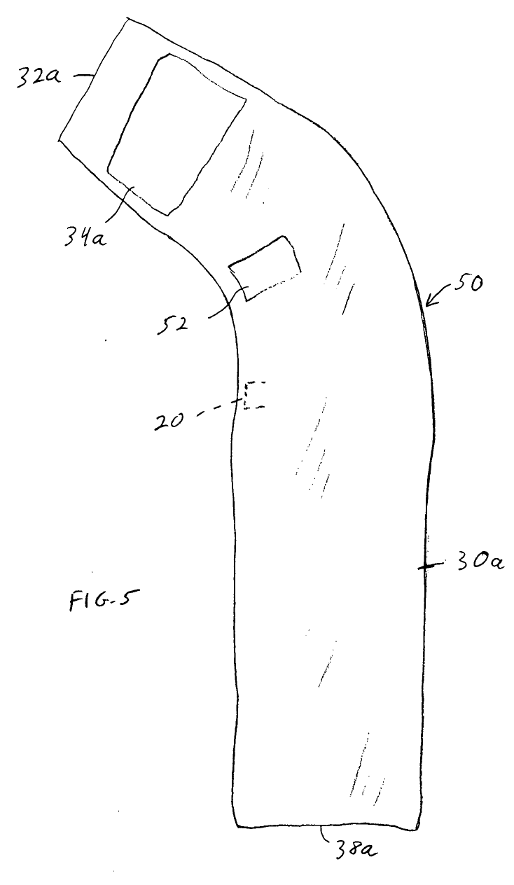

One issue with sleeve 28 is that opening 36 lies fairly close to switch 20, as shown in FIG. 3. This creates the possibility of the user's finger touching the gun around the location of venting area 18 where the gun is exposed by opening 36. This can be alleviated by replacing opening 36 with a smaller opening 52, FIG. 5, which effectively moves this opening farther from switch 20 so that it is less likely that the user's finger will touch the curing gun through opening 52. Otherwise, sleeve 50, FIG. 5, is identical to sleeve 28, FIGS. 2-4.

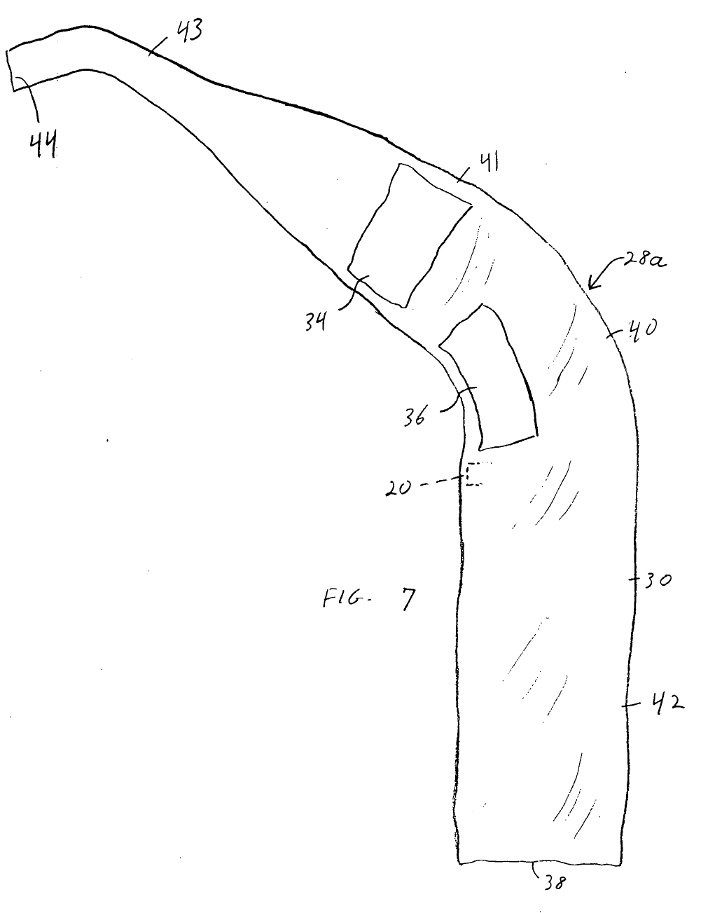

The preferred embodiment of the invention comprises a sleeve that is open only on the end that lies below the handle when the gun is in use. Sleeve 28a, FIG. 7, is designed to fit over dental light curing gun 10, FIG. 6. FIG. 6 shows a fully assembled gun with fiber optic light guide 17 assembled into transmitting end 14. Light guide 17 has distal tip 19 from which the curing light is emitted.

In most cases, it is desirable to cover the entirety of the dental curing light gun as shown in FIG. 6. This then obviates the necessity of having to autoclave any part of the gun. Since the sleeve is made out of clear plastic, the sleeve does not interfere with light transmission from the tip.

Preferably, the shape of the inventive sleeve is generally the same as the shape of the curing gun that it is designed to cover. Preferred embodiment 28a, FIG. 7, thus includes distal extending portion 43 with closed end 44, which together are designed to cover light guide 17, and the distal tip 19 of light guide 17. It is not necessary that the sleeve of the invention exactly follow the shape of the curing gun, as long as it fully covers any portions of the gun that are held by the user or that might touch the patient while in use. Preferably, the sleeve covers the entirety of the gun, of course with the possible exception of one or more openings as necessary to allow for proper venting of the gun.

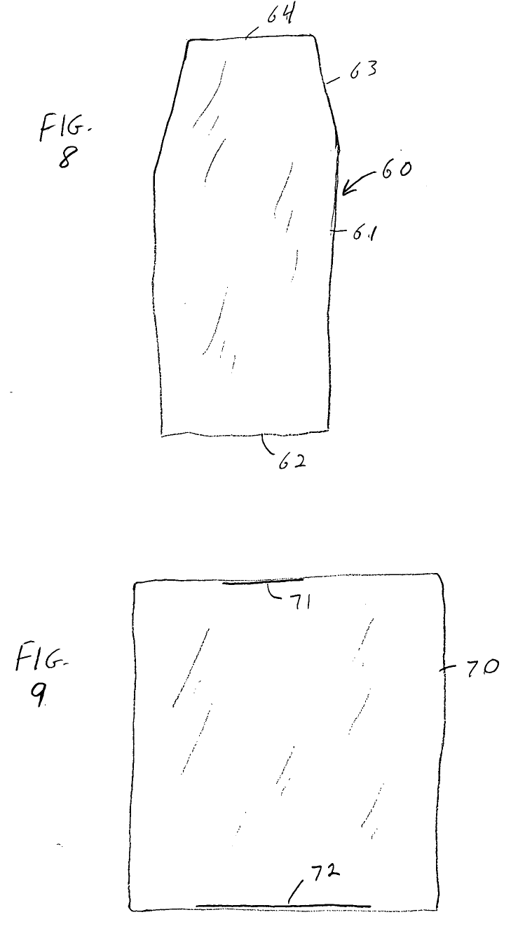

Two alternative embodiments of the inventive sleeve are shown in FIGS. 8 and 9. Disposable protective sleeve 60 of this invention, FIG. 8, includes opening 62 at the proximal end of sleeve 60, intermediate straight portion 61 that would cover the handle and at least some of the curved portion of the gun, and tapered section with preferably closed distal end 64, which together cover the transmitting end and fiber optic light guide attached to the transmitting end of the gun. Alternatively, to create an embodiment like that shown in FIGS. 2-5 with two open ends, end 64 can be partially or fully open. Straight body 61 ends in tapered distal portion 63 that covers the light-emitting end of the gun. This embodiment could also be made from two die cut plastic sheets heat sealed together along their longer edges.

Embodiment 70, FIG. 9, comprises two rectangular sheets heat sealed along all four edges except for opening 72. Alternatively, this opening could be created by partially slitting an already-sealed edge. If a second smaller opening is desired, smaller unsealed edge or slit 71 can be included.

Other embodiments will occur to those skilled in the art and are within the following claims.

1. A disposable protective sleeve for temporarily covering a hand-held dental light curing gun having an elongated handle portion and a barrel portion that tapers to a transmitting end having a light guide from which light emanates, the gun having a curved transitional portion between the handle portion and the barrel portion, the disposable protective sleeve comprising:
a flexible plastic elongated tubular body with an opening at one or both ends;
wherein the body defines a generally straight proximal section and a curved section; and
wherein the larger end opening is larger than the transmitting end, the barrel portion, the transitional portion and the handle portion of the curing gun, so that the sleeve is adapted to be placed over at least most of the curing gun by passing the larger end opening over the transmitting end, barrel portion, transitional portion and handle portion of the curing gun, so that the sleeve covers at least the transitional portion and at least most of the handle portion of the gun.

2. The disposable protective sleeve of claim 1, wherein the tubular body defines a relatively straight section on both sides of the curved section.

3. The disposable protective sleeve of claim 2, wherein the tubular body further defines a narrowed section at the distal end, for covering the light guide of the gun.

4. The disposable protective sleeve of claim 3, wherein the straight section closest to the narrowed section is tapered.

5. The disposable protective sleeve of claim 2, wherein the straight sections extend from the curved section to or close to the ends of the body.

6. The disposable protective sleeve of claim 5, wherein the straight section extending from the curved section toward the distal end is tapered.

7. The disposable protective sleeve of claim 1, wherein the sleeve distal end has a smaller opening.

8. The disposable protective sleeve of claim 1, wherein the sleeve end having the larger opening is larger than the larger opening.

9. The disposable protective sleeve of claim 1 further comprising at least one intermediate opening in the sleeve to allow communication between the curing gun and the atmosphere.

10. The disposable protective sleeve of claim 9, wherein the curing gun has one or more venting areas, each venting areas defining one or more venting openings to allow for cooling of the gun.

11. The disposable protective sleeve of claim 10, wherein the sleeve defines one or more intermediate openings located to expose the curing gun venting areas to facilitate heat transfer from the curing gun.

12. The disposable protective sleeve of claim 1, wherein the body is made from plastic panels joined along at least portions of their edges.

13. A disposable protective sleeve for temporarily covering a hand-held dental light curing gun having an elongated handle portion and a barrel portion that tapers to a transmitting end having a light guide from which light emanates, the gun having a curved transitional portion between the handle portion and the barrel portion, the disposable protective sleeve comprising:
a flexible plastic elongated tubular body open at one end, wherein the tubular body defines relatively straight sections on both sides of a curved section, wherein a proximal straight section extends from the curved section to the proximal open end of the body;
wherein the body defines at least one intermediate opening to allow communication between the curing gun and the atmosphere;
wherein the distal end of the body is narrowed and covers the transmitting end of the curing gun, and is smaller than the transitional portion of the curing gun; and
wherein the end opening is larger than the transmitting end, the barrel portion, the transitional portion and the handle portion of the curing gun, so that the sleeve is adapted to be placed over the entire curing gun by passing the larger end opening over the transmitting end, barrel portion, transitional portion and handle portion of the curing gun, to thereby place the narrowed end over the transmitting end of the gun, so that the sleeve covers the entire gun.

14. The disposable protective sleeve of claim 13, wherein the straight section extending from the curved section toward the distal end is tapered toward the distal end of the sleeve.
